(19) United States
(12) Patent Application Publication
(10) Pub. No.: US 2015/0113400 A1
(43) Pub. Date: Apr. 23, 2015

(54) SERVING CONTENT VIA AN EMBEDDED CONTENT PLAYER WITH A LOOPING FUNCTION

(71) Applicant: Google Inc., Mountain View, CA (US)

(72) Inventors: Sofia Andrianakou, Mountain View, CA (US); Yuanying Xie, Sunnyvale, CA (US)

(73) Assignee: Google Inc., Mountain View, CA (US)

(21) Appl. No.: 14/061,507

(22) Filed: Oct. 23, 2013

(51) Int. Cl. H04L 29/08

(52) U.S. Cl. CPC H04L 67/10
USPC 715/716

(57) ABSTRACT

A system and method for serving content via an embedded content player distributed via a content sharing service with a looping function is provided. The system includes a content analyzer to receive an indication of the content being accessed via the content sharing service; a looping function graphical user interface (GUI) determiner to determine if the content is associated with a looping function, a looping function GUI retriever to retrieve a GUI element based on the determination; and a looping function GUI transmitter to transmit the GUI element to the content sharing service, the GUI element being incorporated via the embedded content player.

### BACKGROUND

Content sharing services serve content, such as pictures, audio, video, text, or combinations thereof, to visitors who access the content sharing service. The content may be sourced from a publisher, automatically generated, or uploaded by one of the visitors to the content sharing service. The content may be represented as digitally encoded information. The content sharing service may store the content, or link to other services and subsequently retrieve the content prior to serving the content to the visitors.

The visitor may employ various techniques to access the content. For example, the visitor may access the content sharing service through a browser or mobile application. In another example, the visitor may access the content sharing service via an application installed on a mobile device. The visitor may employ any sort of device enabled to interact with the content sharing service, such as a personal computer, mobile phone, or an Internet enabled television, for example.

The content sharing service also may serve an embedded content player. The embedded content player may be equipped to manage the content's presentation. The embedded content player may incorporate a play function, a stop function, a pause function, for example.

The embedded content player may be coded in a scripting language compatible with the visitor's browser or mobile application. The visitor, via the browser or mobile application, may download code associated with the embedded content player, and the browser or mobile application may compile the code to present the embedded content player.

The embedded content player may be served in conjunction with content serving. Thus, in response to the visitor accessing content, a subsequent operation serving the embedded content may occur. Alternatively, the visitor may store a cached copy of the embedded content player from a previous access to the content sharing service.

The content sharing service may augment the serving of the content with shared content. The shared content may be served before, during or after the presentation of the content. The shared content may be associated with meta information, and when the shared content is clicked-through by a visitor, the visitor may be redirected to additional content associated with the shared content. The shared content may provide information associated with a product or service related to the content.

### SUMMARY

A system and method for serving content via an embedded content player distributed via a content sharing service with a looping function is provided. The system includes a content analyzer to receive an indication of the content being accessed via the content sharing service; a looping function graphical user interface (GUI) determiner to determine if the content is associated with a looping function; a looping function GUI retriever to retrieve a GUI element based on the determination; and a looping function GUI transmitter to transmit the GUI element to the content sharing service, the GUI element being incorporated via the embedded content player.

### DESCRIPTION OF THE DRAWINGS

The detailed description refers to the following drawings, in which like numerals refer to like items, and in which;

FIG. 1 is a block diagram illustrating an example computer.

FIG. 2 illustrates an example of a system for serving content via an embedded content player distributed via a content sharing service with a looping function.

FIG. 3 illustrates an example of a method for serving content via an embedded content player distributed via a content sharing service with a looping function.

FIG. 4 illustrates an example of a method for inserting shared content in-between a looped content item being served via an embedded content player.

FIGS. 5(a)-(c) illustrate an example of a device accessing a content sharing service implementing the system of FIG. 2.

### DETAILED DESCRIPTION

A content sharing service serves content, and shared content distributed along with the content. The content and shared content may be pictures, audio, video, text, or combinations thereof. The shared content may be served before, during, or after the presentation of content.

The content sharing service may serve an embedded content player. An embedded content player is a code-based application that may be executed by a browser or a mobile application employed by a visitor to access the content sharing service. The embedded content player may be served to the visitor in response to the visitor selecting content, or alternatively, be cached by the visitor from a previous access to the content sharing service.

The embedded content player is scripted or coded in a way to be exclusively accessed via a browser or mobile application. Thus, content served via the content sharing service may be served primarily through the content sharing service, and not stored locally on a visitor's device employed to access the content sharing service.

The visitor may request that a specific content item be repeated. However, the content sharing service may not incorporate a repeating function (or looping function). Conventionally, embedded content players fail to incorporate looping. Thus, the visitor may have to manually select the content item for repeated play.

The visitor may access a third-party service that provides a service of automatically looping a content item being accessed via an embedded content player. However, accessing the third-party service may be cumbersome to the visitor. Further, the visitor may not be cognizant of the third-party service's existence.

Disclosed herein are methods and systems for serving content via an embedded content player distributed via a content sharing service with a looping function. Thus, by engaging the looping function a visitor to the content sharing service may realize multiple and repeated plays of the content. Further, employing the aspects disclosed herein, the content sharing service may be configured to insert shared content in between multiple iterations of the content being served.

The content being looped may be a video, audio, or combination thereof. The decision to loop content may be instigated by a desire to repeatedly consume a certain item. Additionally, the video or audio may be provided by a third-party service, and directed to goods or services.

In situations in which the systems discussed here collect personal information about users, or may make use of personal information, the users may be provided with an opportunity to control whether programs or features collect user information (e.g., information about a user's social network, social actions or activities, profession, a user's preferences, or a users current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a users geographic location may be generalized where location information is obtained (such as to a city, ZIP code, or state level), so that a particular location of a user cannot be determined. Thus, the user may have control over how information is collected about the user and used by a content server.

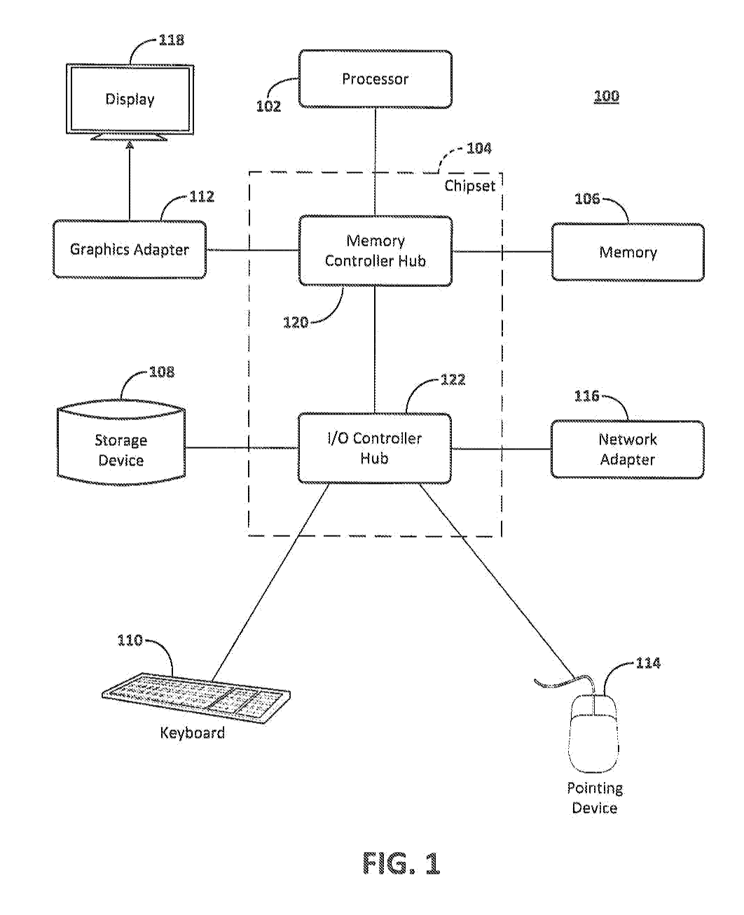

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server. The various computer 100 devices that constitute the server may communicate with each other over a network 250.

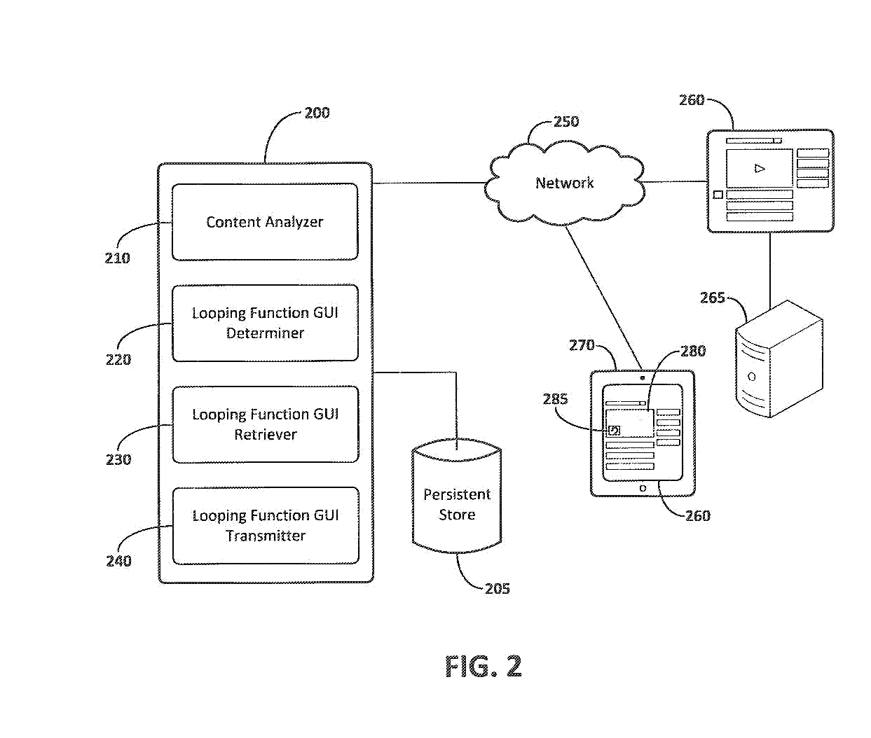

FIG. 2 illustrates an example of a system 200 for serving content via an embedded content player distributed via a content sharing service 260 with a looping function 285. The system 200 includes a content analyzer 210, a looping function graphical user interface (GUI) determiner 220, a looping function GUI retriever 230, and a looping function GUI transmitter 240.

The system 200 may communicate with the content sharing service 260 via network 250. Alternatively, the system 200 may be incorporated or implemented with the content sharing service 260. The content sharing service 260 may be stored on a server 265. The server 265 may be any device, such as computer 100 described above.

A visitor to the content sharing service 260 may employ a device 270. The device 270 may be any sort of computing device, such as those enumerated above in regards to computer 100. As shown in FIG. 2, the device 270 is presently accessing content sharing service 260. In FIG. 2, the content sharing service 260 is presently serving content item 280 to device 270.

The content analyzer 210 receives an indication that device 270 has accessed the content sharing service 260 via the network 250. For example, device 270's operator may access a specific content item 280 via an embedded player. In response to the content item 280 being accessed, the system 200 may be transmitted an indication of such via the content sharing service 260.

The looping function graphical user interface (GUI) determiner 220 ascertains whether the content item 280 is associated with a looping function.

The looping function GUI determiner 220 may access a lookup table stored in a persistent store 205. The lookup table may indicate whether the specific content item 280 is associated with the looping function. Alternatively, if the specific content item 280 is not associated with a looping function, the lookup table may contain rules associated with whether a content item 280 is to be served along with a looping function.

For example, the rules may be defined to indicate whether the content item is over a certain length, belongs to a certain genre, or similar to other content items associated with a looping function.

The looping function GUI retriever 230 retrieves a GUI element 285 based on the determination made by the looping function GUI determiner 220. The GUI element 285, as shown in FIG. 2, is a graphical element that indicates to device 270's operator that asserting the GUI element 285 causes the content sharing service 260 to loop the content item 280.

In certain cases, the GUI element 285 may be augmented with an entry to enter a number. The number may be entered by device 270's operator to indicate how many times a content item 280 is to be repeated.

The looping GUI transmitter 240 transmits the GUI element 285 to the content sharing service 260. Accordingly, the content sharing service 260 may serve GUI element 285 along with the content item 280 being presently accessed by the device 270. In response to device 270's operator engaging the GUI element 285, the content sharing service 260 may automatically serve the content item 280 in a repeated fashion.

The looping GUI transmitter 240 may also transmit an instruction to the content sharing service 260 to serve shared content in-between the multiple iterations of content item 280 being served. The looping GUI transmitter 240 may include a number associated with the shared content, with the number indicating how many times the content item 280 is looped before the shared content is served. This number may be predefined per content item, per the visitor accessing the content sharing service 260, or based on a content items genre or length, for example.

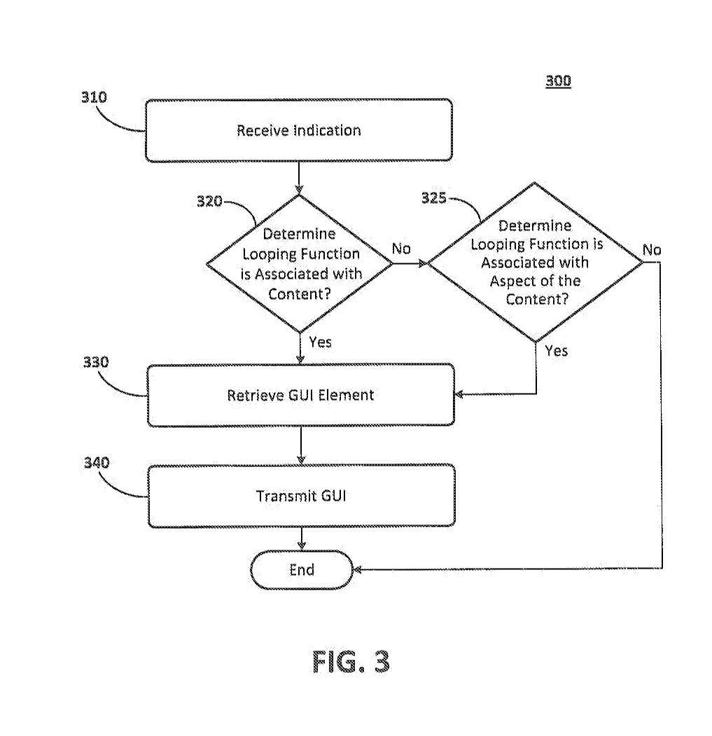

FIG. 3 illustrates an example of a method 300 for serving content via an embedded content player distributed via a content sharing service with a looping function. The method 300 may be implemented on a device, such as system 200.

In operation 310, an indication that content has been accessed from a content sharing service is received. An operator of a device accessing the content sharing service may select a specific content item, or alternatively, the content sharing service may serve a specific content item automatically. In either case, an indication of such is received in operation 310.

In operation 320, a determination is made as to whether a looping function is associated the content item accessed (as indicated in operation 310). If the content item is associated with a looping function, the method proceeds to operation 330.

If the content item is not associated with a looping function, a determination in operation 325 is made as to whether an aspect of the content item is predetermined to be served with a looping function. For example, the aspect may be a content item from a specific publisher, content item that belongs to a certain genre, or content items that are longer than a predetermined length. If the determination is that the content item is not to be served with a looping function, the method 300 proceeds to an end. Conversely, if the determination is that the content item is to be served with a looping function, the method 300 ends.

In operation 330, a GUI element associated with the looping function is retrieved. Alternatively, en indication or command to embed a GUI element to allow a looping function may be retrieved. The GUI element may be an additional code or a function that may augment an embedded content player served by the content sharing service. Alternatively, the embedded content player may already incorporate an ability to serve a looping function, and thus, employ the indication or command to display the looping function in association with serving of the specific content item.

In operation 340, the retrieved GUI element is transmitted to the content sharing service. Accordingly, the content sharing service may provide a looping function associated with the GUI element to present along with the content serving. Thus, a device's operator may instigate the GUI element, thereby causing the content presently being served to be repeatedly served. In another example, the GUI element may contain an input to enter a specific number. The specific number may be employed to instruct the content player to serve the content associated with the looping function for a specific number of times.

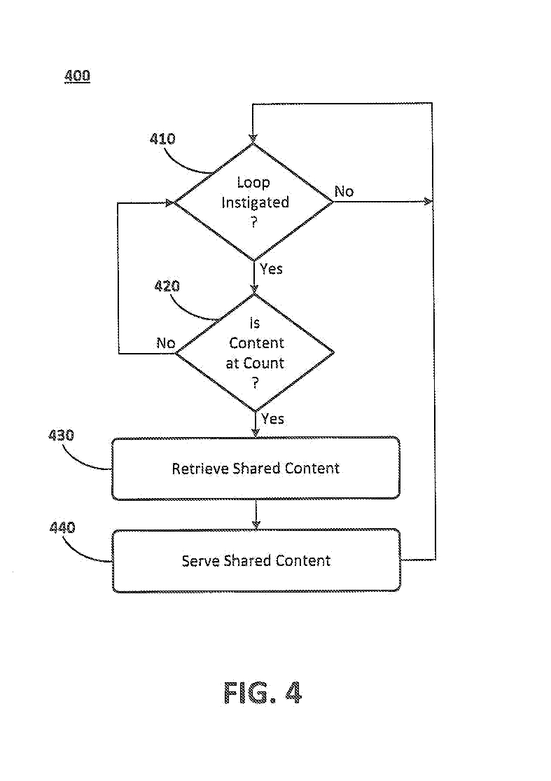

FIG. 4 illustrates a method 400 for inserting shared content in-between a looped content item being served via an embedded content player. The method 400 may be incorporated with method 300, and be implemented via a device, such as system 200.

In operation 410, a content snaring service detects whether a looping function has been instigated. For example, a device's operator, while accessing a content item via the content sharing service, may instigate the looping function (such as GUI element 285 shown in FIG. 2).

In operation 420, a count associated with the number of times the content item has been repeated is compared against a predetermined count number. If the count is at the predetermined count number, the method 400 proceeds to operation 430. If the count is not at a predetermined number, the method 400 proceeds to operation 410.

The predetermined count number may be set by an implementer of method 400 to insert a shared content item in-between a predetermined count number of iterations of serving of the content item. The predetermined count number may be dynamic, and thus change during the looping of the content item.

In operation 430, shared content is retrieved. The shared content may be retrieved based on any heuristic employed to serve shared content to a visitor to a content sharing service, For example, shared content may be retrieved that is related to the content item being looped.

In operation 440, after a current iteration of the content item has finished serving, the content sharing service may present the shared content retrieved in operation 430 to the content sharing service's visitor. After which, the content sharing service may resume serving the content item being looped, and the method 400 may proceed back to operation 410.

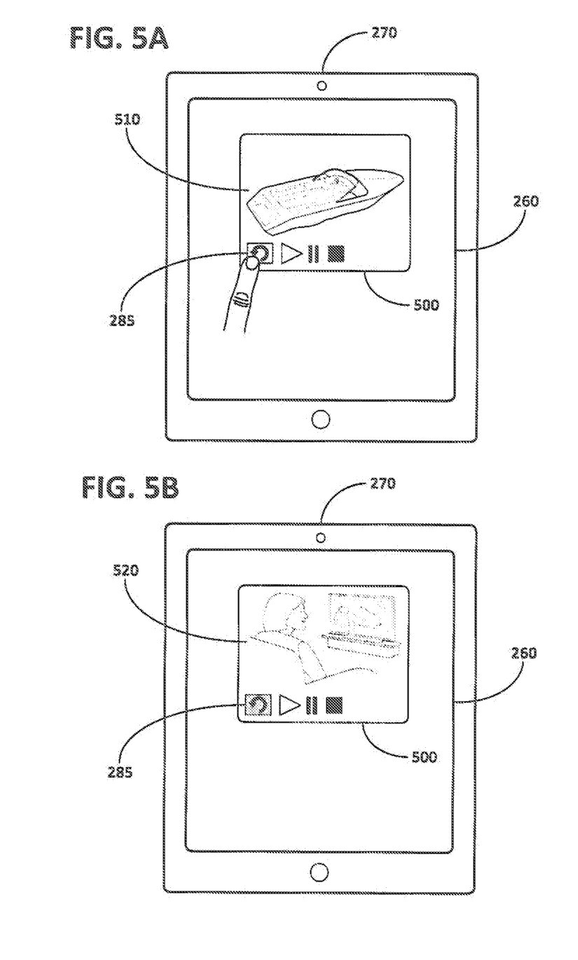

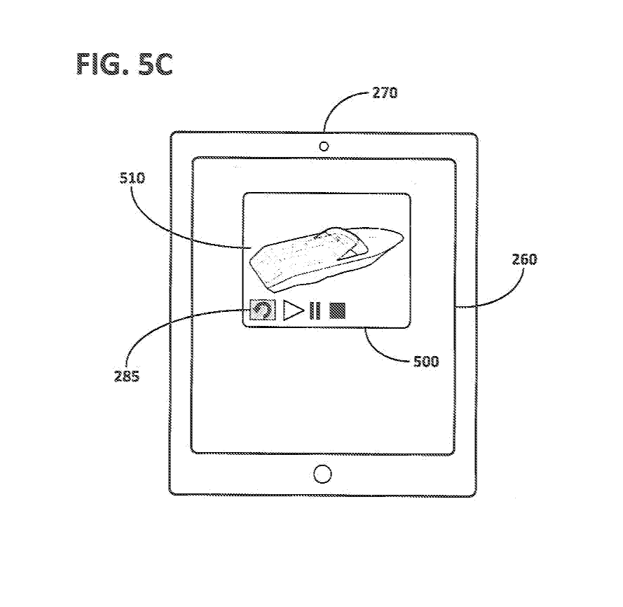

FIGS. 5(a)-5(c) illustrate an example of a device 270 accessing a content sharing service 260 implementing system 200. The device 270 may be any sort of mobile device used to access a content sharing service 260, such as those enumerated above in regards to computer 100.

Referring to FIG. 5(a), an embedded content player 500 in a browser window is shown. The browser window may be associated with an application executed on the device 270, employed to access the content sharing service 260. The embedded content player 500 includes a content item 510 presently being served with a looping function 285. In FIG. 5(a), the looping function 285 is instigated, as shown by a finger accessing the looping function.

Referring to FIG. 5(b), an iteration of the content item 510 has finished being served. Accordingly, the content sharing service 260 may retrieve shared content item 520 to present after the content item 510. Thus, in FIG. 5(b), the browser window now contains the embedded content player 500 serving shared content 520. The shared content 520 may be retrieved according to operation 430 described above.

Referring to FIG. 5(c), the shared content 520 has finished being served. Accordingly, the content sharing service 260, via the embedded content player 500, now resumes serving another iteration of content item 500. As shown in FIG. 5(c), the looping function 285 is shaded, thereby indicating that the embedded content player 500 is looping content.

Thus, employing the aspects disclosed herein, a content sharing service may serve content with a looping function. Additionally, in response to the looping function being instigated, the content sharing service may also realize revenue associated with inserting shared content in between the iterative serving of the content items.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture o graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIGS. 3 and 4. The disclosed devices, components, and systems contemplate using or implementing any suitable technique for performing the steps illustrated in these figures. Thus, FIGS. 3 and 4 are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

1. A system for serving content via an embedded content player distributed via a content sharing service with a looping function, comprising:
a data store comprising a computer readable medium storing a program of instructions for the serving of the content;
a processor that executes the program of instructions;
a content analyzer to receive an indication of the content being accessed via the content sharing service;
a looping function graphical user interface (GUI) determiner to determine if the content is associated with a looping function;
a looping function GUI retriever to retrieve a GUI element based on the determination; and
a looping function GUI transmitter to transmit the GUI element to the content sharing service, the GUI element being incorporated via the embedded content player, wherein
in response to the GUI element being activated the content is repeatedly served, and
in-between iterations of the content being served, shared content is served.

2. The system according to claim 1, wherein in response to the looping function GUI determiner determining that the content is not associated with a looping function, determining whether an aspect of the content is associated with the looping function.

3. The system according to claim 2, wherein the aspect is the content's length.

4. The system according to claim 3, wherein the aspect is the contents genre.

5. The system according to claim 1, wherein the looping function GUI transmitter transmits an indication to the embedded content player to add the looping function.

6. The system according to claim 1, wherein the shared content is served after a predetermined number of servings of the content.

7. The system according to claim 1, wherein the looping function further comprises a selection area to insert a number, the number corresponding to a number of times the content is looped.

8. A method implemented on a processor for serving content via an embedded content player distributed via a content sharing service with a looping function, comprising:
receiving an indication that the content is accessed via the content sharing service;
determining whether the content is associated with a looping function;
in response to the determination, retrieving a graphical user interface (GUI) element associated with the looping function, and
transmitting the GUI element to the content sharing service, wherein
the embedded content player incorporates the GUI element,
in response to the GUI element being activated, the embedded content player loops the content,
in-between iterations of the content, the content sharing service serves shared content, and
the determining being performed via the processor.

9. The method according to claim 8, wherein in response to determining that the content is not associated with the looping function, determining whether an aspect of the content is associated with the looping function.

10. The method according to claim 9, wherein the aspect is the content's length.

11. The method according to claim 9, wherein the aspect is the content's genre.

12. The method according to claim 8, further comprising transmitting an indication to the embedded content player to add the looping function.

13. The method according to claim 8, wherein the shared content is served after a predetermined number of servings of the content.

14. The method according to claim 8, further comprising presenting a selection area via the embedded content player to insert a number, the number corresponding to a number of times the content is looped.

15. A method implemented on a processor for inserting shared content in-between looped content being served via an embedded content player, comprising:
detecting if the embedded content player is presently serving the content with the loop function activated;
retrieving shared content to serve with the content; and
inserting the shared content in-between the serving of multiple iterations of the content, wherein
the inserting is performed by the processor.

16. The method according to claim 15, wherein the inserting occurs after the content is served at least a predetermined number of times.

17. The method according to claim 15, wherein the shared content is retrieved based on the content.

18. The method according to claim 15, wherein the shared content is retrieved based on a visitor accessing the content sharing service.

19. An embedded content player, comprising:
detecting if the embedded content player is presently serving content with a loop function activated;
retrieving shared content to serve with the content; and
inserting the shared content in-between the serving of multiple iterations of the content,
wherein the embedded content player is stored on a non-volatile storage device.
